(19) United States
(12) Patent Application Publication
(10) Pub. No.: US 2014/0067891 A1
(43) Pub. Date: Mar. 6, 2014

(54) PSEUDO RANDOM NUMBER GENERATOR AND METHOD FOR PROVIDING A PSEUDO RANDOM SEQUENCE

(71) Applicant: Infineon Technologies AG, (US)

(72) Inventor: Rainer Goettfert, Putzbrunn (DE)

(73) Assignee: Infineon Technologies AG, Neubiberg (DE)

(21) Appl. No.: 13/857,191

(22) Filed: Apr. 5, 2013

(30) Foreign Application Priority Data
Apr. 5, 2012 (DE) 102012205620.3

(51) Int. Cl. G06F 7/58

(52) U.S. Cl. CPC G06F 7/584
USPC 708/252

(57) ABSTRACT

In various embodiments, a pseudo random number generator is provided. The pseudo random number generator may include: a pair of shift registers, wherein a first shift register in the pair is a linear shift register and a second shift register in the pair is a nonlinear shift register, wherein the linear shift register is configured to receive a first output sequence from the nonlinear shift register, and to take the first output sequence as a basis for providing a second output sequence; wherein the pseudo random number generator is configured to take the second output sequence as a basis for providing a pseudo random sequence.

### CROSS-REFERENCE TO RELATED APPLICATION

This application claims priority to German Patent Application Serial No. 10 2012 205 620.3, which was filed Apr. 5, 2012, and is incorporated herein by reference in its entirety.

### TECHNICAL FIELD

Various embodiments provide a pseudo random number generator. Furthermore, various embodiments provide a method for providing a pseudo random sequence.

### BACKGROUND

Pseudo random number generators are often used for encryption. It is therefore desirable to make pseudo random number generators robust against attacks, such as against correlation attacks.

### SUMMARY

In various embodiments, a pseudo random number generator is provided. The pseudo random number generator may include: a pair of shift registers, wherein a first shift register in the pair is a linear shift register and a second shift register in the pair is a nonlinear shift register, wherein the linear shift register is configured to receive a first output sequence from the nonlinear shift register, and to take the first output sequence as a basis for providing a second output sequence; wherein the pseudo random number generator is configured to take the second output sequence as a basis for providing a pseudo random sequence.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a block diagram of a pseudo random number generator based on an embodiment;

FIG. 2 shows exemplary implementations for a linear shift register and a nonlinear shift register, as may be used in embodiments;

FIG. 3 shows a block diagram of a pseudo random number generator based on a further embodiment; and

FIG. 4 shows a flowchart of a method based on a further embodiment.

### DESCRIPTION

The following detailed description refers to the accompanying drawings that show, by way of illustration, specific details and embodiments in which the invention may be practiced.

Before exemplary embodiments of the present invention are described in detail below with reference to the accompanying figures, it is pointed out that the same elements or elements having the same function are provided with the same reference symbols and that a repeat description of elements which are provided with the same reference symbols is omitted. Descriptions of elements having the same reference symbols are therefore interchangeable with one another.

Various embodiments provide a concept which allows a more robust pseudo random number generator.

Various embodiments provide a pseudo random number generator which has a pair of shift registers. A first shift register in the pair is a linear shift register and a second shift register in the pair is a nonlinear shift register. The linear shift register is configured to receive a first output sequence from the nonlinear shift register and to take the first output sequence as a basis for providing a second output sequence. The pseudo random number generator is configured to take the second output sequence as a basis for providing a pseudo random sequence.

Further embodiments provide a method for providing a pseudo random sequence having a step of provision of a first output sequence by a nonlinear shift register, a step of reception of the first output sequence and of provision of a second output sequence on the basis of the first output sequence by a linear shift register, and a step of provision of the pseudo random sequence on the basis of the second output sequence.

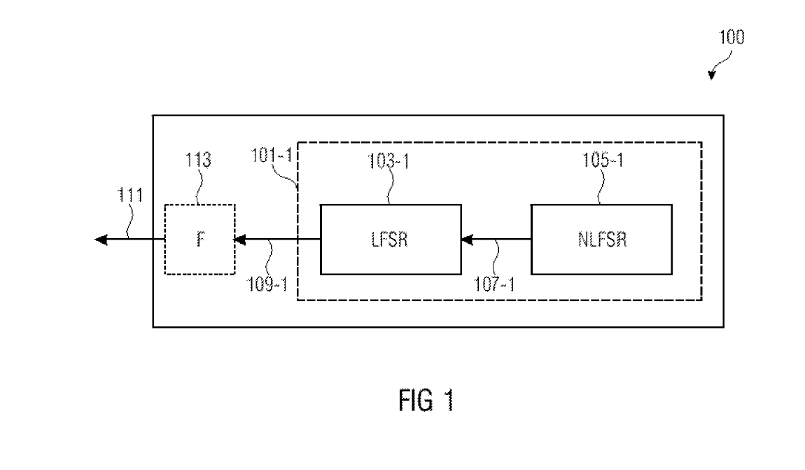

FIG. 1 shows a block diagram of a pseudo random number generator 100 based on an embodiment. The pseudo random number generator 100 has a pair 101-1 of shift registers 103-1, 105-1. A first shift register 103-1 in the pair 101-1 is a linear (feedback and/or binary) shift register 103-1, for example an LFSR (linear feedback shift register).

A second shift register 105-1 in the pair 101-1 is a nonlinear (feedback and/or binary) shift register 105-1, for example an NLFSR (non linear feedback shift register). The linear shift register 103-1 is configured to receive a first output sequence 107-1 from the nonlinear shift register 105-1 and to take the received first output sequence 107-1 as a basis for providing a second output sequence 109-1. The random number generator 100 is configured to take the second output sequence 109-1 as a basis for providing a pseudo random sequence 111.

It is a concept of various embodiments that a pseudo random number generator that is more resistant to correlation attacks can be provided when the pseudo random sequence 111 is generated on the basis of a combination of shift registers 103-1, 105-1 of different natures or types of shift registers (such as linear and nonlinear).

The combination of shift registers 103-1, 105-1 which are shown in FIG. 1 allows a much smaller implementation, with at least equally good resistance to correlation attacks, particularly in comparison with systems in which just linear shift registers are used for providing a pseudo random sequence. In addition, the combination of the two shift registers 103-1, 105-1 which is shown in FIG. 1 makes it possible to overcome the disadvantage of low resistance to correlation attacks of pseudo random number generators which are based just on nonlinear shift registers.

It has been recognized that, when linear shift registers are used, protection against attacks is achieved only when a large number (e.g. thirty or more) of linear shift registers are used, specifically such linear shift registers as are approximately 100 cells long. The hardware costs for such a design therefore run up to approximately 3000 memory cells and therefore require a high level of implementation outlay. In addition, it has been recognized that the designs which are based on nonlinear shift registers have the disadvantage that they are less resistant to correlation attacks than the “fat” designs described, which are based on linear shift registers. For example, a hacker who knows scarcely 2⁵⁰ successive bits of the sequence can use a computation outlay of approximately 2¹⁰⁰ operations to calculate the present content of the nonlinear shift registers. This is critical, since in this example a key length or “seed length” of 128 bits is assumed and there is therefore not meant to be any attack which has significantly less computation outlay than 2¹²⁸. In addition, it has also been recognized that good nonlinear shift registers which allow the aforementioned problem to be overcome are not available or cannot be constructed.

Various embodiments, such as the pseudo random number generator 100 shown in FIG. 1, overcome the aforementioned problems by virtue of the combination of the linear shift register 103-1 and the nonlinear shift register 105-1. By way of example, it is thus possible for a small (and therefore available) nonlinear shift register 105-1 and a somewhat larger good linear shift register 103-1 to be attached to one another. To be more precise, the first output sequence 107-1 produced or provided by the nonlinear shift register 105-1 can be fed directly into the linear shift register 103-1. The second output sequence 109-1 (which is an output sequence from the combination or pair 101-1 of the linear shift register 103-1 and the nonlinear shift register 105-1) can serve as a basis for the pseudo random sequence 111. By way of example, the pseudo random number generator 100 may have a (Boolean) combination function 113 which is configured to take the second output sequence 109-1 as a basis for producing and providing the pseudo random sequence 111. In other words, the second output sequence 109-1 from the pair 101-1 can form an input sequence for the Boolean combination function 113 (also called F). In other words, embodiments can—since good nonlinear shift registers in arbitrary size are not available—have a combination of a linear shift register 103-1 and a nonlinear shift register 105-1, as shown in FIG. 1, as a replacement for a good nonlinear shift register of this kind.

The pair including the linear shift register 103-1 and the nonlinear shift register 105-1 can therefore also be called an S extender or seed extender, since, in comparison with systems which include only linear shift registers or only nonlinear shift registers, it is possible to achieve at least as great or even greater resistance to correlation attacks with the same size “seed” or initial value for lower implementation outlay.

A nonlinear shift register is also called a nonlinear feedback shift register, NLFSR for short, and can also be called a nonlinear feedback (binary) shift register. A linear shift register is also called a linear feedback shift register, LFSR for short, and can also be called a linear feedback (binary) shift register.

On the basis of some exemplary embodiments, the linear shift register 103-1 may have maximum periodicity. A shift register of length n is deemed to have maximum periodicity when it produces an output sequence of period 2ⁿ−1 for any initial content different than the all zero state.

On the basis of further embodiments, the nonlinear shift register 105-1 may also have maximum periodicity.

The use of maximum periodicity shift registers allows maximum security against correlation attacks for minimal necessary implementation outlay.

On the basis of some embodiments, a length of the nonlinear shift register 105-1 (for example a number of memory elements of the nonlinear shift register 105-1) can be chosen to be less than or equal to a length of the linear shift register 103-1 (for example a number of memory elements of the linear shift register 103-1). On the basis of some embodiments, a length of the nonlinear shift register 105-1 (for example a number of memory elements of the nonlinear shift register 105-1) can be chosen to be in a range between ≧5 and ≦50 or chosen to be in a range between ≧20 and ≦35.

On the basis of further embodiments, a length of the linear shift register 103-1 can be chosen to be in a range between ≧5 and ≦50 (for example in a range around 10 memory elements) longer than the length of the associated nonlinear shift register 105-1.

The output sequences 107-1, 109-1 generated by the shift registers 103-1, 105-1 may be binary sequences. By way of example, it is thus possible for each of the shift registers 103-1, 105-1 to be configured to output one new bit in the respective output sequence 107-1, 109-1 per clock pulse or clock edge.

On the basis of some exemplary embodiments, the pseudo random number generator may be configured to load an initial value or “seed” into the nonlinear shift register 105-1 (said initial value in this case being different than an all zero state, for example). In addition, the pseudo random number generator 100 may also be configured to load an initial state or “seed” into the linear shift register 103-1 (said initial state in this case even being able to assume the all zero state, for example).

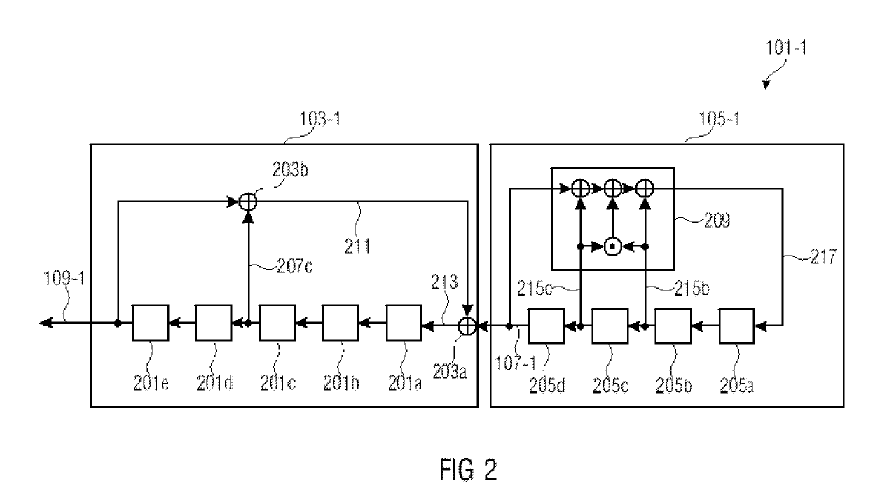

FIG. 2 shows a possible nonrestricted implementation of the pair 101-1 or of the LFSR-NLFSR combination 101-1 from the linear shift register 103-1 and the nonlinear shift register 105-1. In the example shown in FIG. 2, the linear shift register 103-1 has a length of 5 (i.e. the linear shift register 103-1 has five (memory) cells or memory elements 201a-201e which are connected in series between an input of the linear shift register 103-1 and an output of the linear shift register 103-1). In addition, the nonlinear shift register 105-1 has a length of 4 (i.e. the nonlinear shift register 105-1 has four (memory) cells or memory elements 205a-205d which are connected in series between an input of the nonlinear shift register 105-1 and an output of the nonlinear shift register 105-1). In a real implementation, typically both the length of the linear shift register 103-1 and the length of the nonlinear shift register 105-1 were chosen to be much greater in this case. The example shown in FIG. 2 is therefore intended to serve merely for the better understanding of embodiments. The first output sequence 107-1 generated by the nonlinear shift register 105-1 is in this case fed into the linear shift register 103-1.

A memory element output sequence generated by a final memory element 201e of the linear shift register 103-1 forms the second output sequence 109-1 from the linear shift register 103-1 and hence simultaneously also the output sequence from the pair 101-1.

The linear shift register 103-1 has a first logic combination 203a. In addition, the first linear shift register has a second logic combination 203b.

The second logic combination 203b is configured to logically combine the second output sequence 109-1 with a memory element output sequence 207c from a third memory element 201c of the linear shift register 103-1 in order to obtain a first logically combined output sequence 211. The first logic combination 203a is configured to logically combine the first logically combined output sequence 211 with the first output sequence 107-1 in order to obtain a second logically combined output sequence 213. The second logically combined output sequence 213 is used as an input sequence for a first memory element 201a of the linear shift register 103-1.

In this case, the memory elements 201a-201e of the linear shift register 103-1 are connected up to one another in series. Each of the memory elements 201a-201e forwards the bit which is present at its input to the output per unit time (per clock pulse or clock edge).

On the basis of some embodiments, the logic combinations 201a and 201b may be simple one-bit additions (without carry).

The linear shift register 103-1 of length 5 will first of all be considered in isolation below. When it is initialized with an initial value that is different than zero (i.e. 00000), it produces an output sequence of period 31 (=2⁵−1). As an example, an initial content of 00111 produces the output sequence:

0011111000110111010100001001011.

This sequence has the period 31 and the linear complexity 5.

A note regarding linearity: if A=A1, A2, A3, . . . is an arbitrary periodic bit sequence, this sequence can always also be generated by a suitable linear shift register. The length of the shortest linear shift register that can be used to generate the given sequence A is called the linear complexity of A. In other words, both the linear complexity of a nonlinear shift register (such as the nonlinear shift register 105-1) and the linear complexity of a linear shift register (such as the linear shift register 103-1) are ascertained on the basis of the same criterion.

The nonlinear shift register 105-1 has a logic combination 209 which is configured to take the first output sequence 107-1 and a memory element output sequence 215b from a second memory element 205b of the nonlinear shift register 105-1 and also to take a memory element output sequence 215c from a third memory element 205c of the nonlinear shift register 105-1 as a basis for obtaining an input sequence 217 for a first memory element 205a of the nonlinear shift register 105-1.

The logic combination 209 has three linear combinations (for example additions) and one nonlinear combination (for example a multiplication).

As in the case of the linear shift register 103-1 already, the nonlinear shift register 105-1 also has its memory elements 205a-205d connected up to one another in series. In addition, the memory elements 205a-205d are also one-bit memory elements which are configured to provide the value which is present at their input (for example bit value logic 0 or logic 1) at their output upon every clock pulse (or every clock edge).

The linear shift register 105-1 (or the NLFSR 105-1) of the length 4 will now be considered in isolation below. When it is filled with an initial value or seed that is different than zero (i.e. 0000), it produces an output sequence of period 15 (=2⁴−1). As an example, the initial content 0001 produces the output sequence 000101101001111. This sequence has the period 15 and the linear complexity 14 (2ⁿ−2).

The whole LFSR-NLFSR combination or construction 101-1 shown in FIG. 2 (in other words the pair 101-1) will now be considered below. When the four cells 205a-205d of the (driving) nonlinear shift registers 105-1 are initialized in arbitrary fashion, such that not all cells are loaded with a zero, and when the five cells 201a-201e of the linear shift register 103-1 (receiving the first output sequence 107-1) are initialized in arbitrary fashion (in this case the all zero state is also permissible), the whole LFSR-NLFSR combination 101-1 (or the pair 101-1) generally produces an output sequence (the second output sequence 109-1) of period 15×31=465 and the linear complexity 5+14=19.

This relationship will now be explained once again below with the aid of a general example.

An LFSR-NLFSR combination or a pair including a linear shift register and a nonlinear shift register based on an embodiment is thus considered in which an input sequence for the linear shift register is based on an output sequence from the nonlinear shift register and an output sequence from the pair corresponds to an output sequence from the linear shift register. The linear shift register is assumed to have maximum periodicity and to have the length n. The nonlinear shift register is assumed to have maximum periodicity with the length n. The nonlinear shift register is assumed to have the linear complexity h. That is to say that the linear complexity of a—and hence of any—nontrivial output sequence from the linear shift register is h. In this case, it should be borne in mind that the only trivial output sequence from the nonlinear shift register is the zero sequence. Typically, h is only slightly smaller than the period length of a nontrivial output sequence from the nonlinear shift register, for example h=2ⁿ−2.

The following is then true: when the linear shift register is initialized in arbitrary fashion and the nonlinear shift register is initialized with an arbitrary initial value that is different than all zero, the output sequence from the associated LFSR-NLFSR construction (for example the second output sequence 109-1) has the probability W=1-2^{-m} of having a period P=(2^{m}−1)×(2ⁿ−1) and the linear complexity L=m+h. The output sequence from the LFSR-NLFSR construction (for example the second output sequence 109-1) has the probability W=2^{-m} of having the period length P=2ⁿ−1 and the linear complexity L=h.

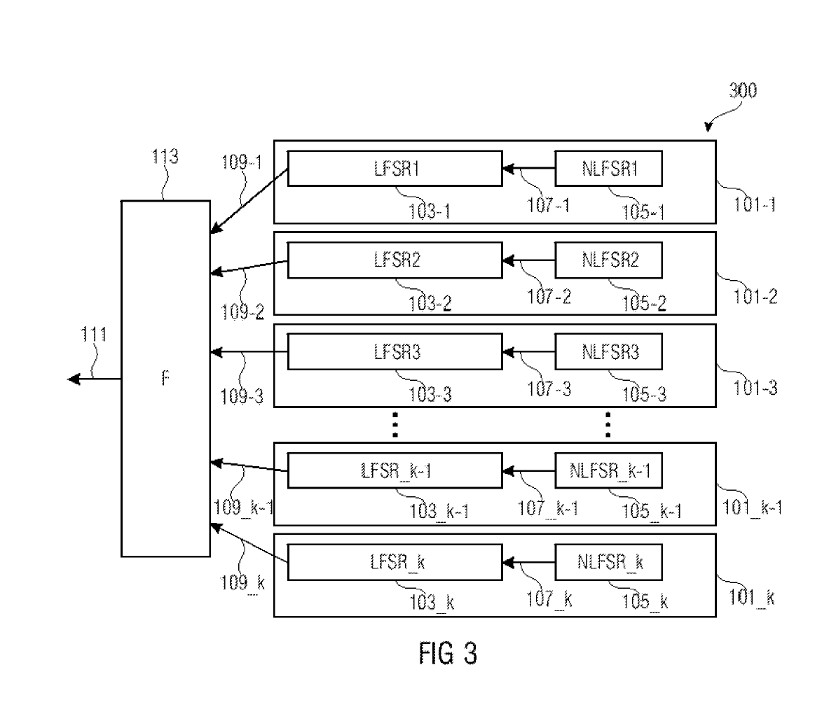

FIG. 3 shows a block diagram of a pseudo random number generator 300 based on a further embodiment. The pseudo random number generator 300 shown in FIG. 3 is different than the pseudo random number generator 100 shown in FIG. 1 in that, in addition to the pair 101-1 of shift registers 103-1, 105-1, it has further pairs 101-2 to 101-k of shift registers which each have a linear shift register 103-2 to 103-k and a nonlinear shift register 105-2 to 105-k. The design of the individual pairs 101-1 to 101-k of shift registers is identical in the respect that each of the pairs 101-1 to 101-k of shift registers has a linear shift register 103-1 to 103-k and a nonlinear shift register 105-1 to 105-k, respectively, with the nonlinear shift register 105-1 to 105-k in each case being configured to provide a first output sequence 107-1 to 107-k. The linear shift registers 103-1 to 103-k of the pair 101-1 to 101-k of shift registers are each configured to receive this first output sequence 107-1 to 107-k from their respective associated nonlinear shift register 105-1 to 105-k and to take this received first output sequence 107-1 as a basis for providing a second output sequence 109-1 to 109-k. The pseudo random number generator 300 (or to be more precise the logic (for example Boolean) combination function 113) is configured to take the plurality of received second output sequences 109-1 to 109-k as a basis for providing the pseudo random sequence or the pseudo random number sequence 111.

On the basis of some embodiments, at least for some of the plurality of pairs 101-1 to 101-k of shift registers, different nonlinear shift registers 105-1 to 105-k in different pairs 101-1 to 101-k may have different lengths.

On the basis of further exemplary embodiments, even for some of the plurality of pairs 101-1 to 101-k, linear shift registers 103-1 to 103-k in different pairs 101-1 to 101-k may have different lengths.

In other words, the pairs 101-1 to 101-k of shift registers may differ in that, at least for some of the pairs 101-1 to 101-k, the lengths of their linear shift registers 103-1 to 103-k and/or of their nonlinear shift registers 105-1 to 105-k may be different than one another.

The pseudo random number generator 300 shown in FIG. 3 thus includes k LFSR-NLFSR combinations 101-1 to 101-k. When k=15 is chosen and the lengths of the nonlinear shift registers 105-1 to 105-k are chosen to be between 20-35 and the length of a linear shift register 103-1 to 103-k is chosen to be approximately ten cells longer than the length of the associated nonlinear shift register 105-1 to 105-k (which is part of the same pair as the linear shift register), and when a good combination function 113 is chosen and when again a key (=seed) of bit length 128 has been chosen, it is true of the pseudo random sequence produced by the pseudo random number generator 300, or the pseudo random sequence produced by the generator 300, that it is at least resistant to correlation attacks up to data lengths of 2¹⁰⁰.

It should be noted that for the output sequence 111 from the whole pseudo random number generator 300—specifically for each chosen combination function 113—the period and the linear complexity of this pseudo random sequence 111 can be estimated. This means that upper and lower limits can be derived for the period and linear complexity of the pseudo random sequence 111.

The linear shift registers 103-1 to 103-k and nonlinear shift registers 105-1 to 105-k used in the generator 300 shown in FIG. 3 should not have their order changed. If this were to be done, that is to say that the LFSR output sequences were each to be fed into a nonlinear shift register and the sequences produced in this way were then to be combined with a combination function F, a “chaotic generator” would be obtained: in this case, no sensible lower limits can be specified for period and linear complexity of the pseudo random sequence produced. In actual fact, period length and linear properties then vary greatly with the key used (the seed). This is an undesirable property, however.

In summary, various embodiments provide a design for a pseudo random number generator which is more robust toward correlation attacks.

The operation of the pseudo random number generator 300 will be described once again in detail below.

The design of the pseudo random number generator 300 shown in FIG. 3 has a plurality of linear feedback binary shift registers 103-1 to 103-k and a plurality of nonlinear feedback binary shift registers 105-1 to 105-k. The shift registers 103-1 to 103-k, 105-1 to 105-k are initially loaded with a secret key, what is known as the seed. They then run independently of one another. In this case, each of the shift registers 103-1 to 103-k, 105-1 to 105-k produces an output sequence 107-1 to 107-k, 109-1 to 109-k. The second output sequences 109-1 to 109-k from the linear shift registers 103-1 to 103-k are logically combined with one another by means of the combination logic 113 (also called Boolean combination function 113) and the resulting bit sequence is the pseudo random sequence 111. In this case, the combinational logic operation is performed on a bit-by-bit basis, i.e. each linear shift register 103-1 to 103-k outputs one bit per unit time (for example per clock pulse or clock edge). These bits form the respective second output sequence 109-1 to 109-k from the linear shift register 103-1 to 103-k. The bits per clock pulse and hence the second output sequences 109-1 to 109-k from the linear shift registers 103-1 to 103-k form the input for the combination function 113. The combination function 113 produces an output bit therefrom (per clock pulse or clock edge). This is the pseudo random bit, produced at time t. The method is repeated at time t+1, t+2, . . . . This produces the pseudo random sequence 111.

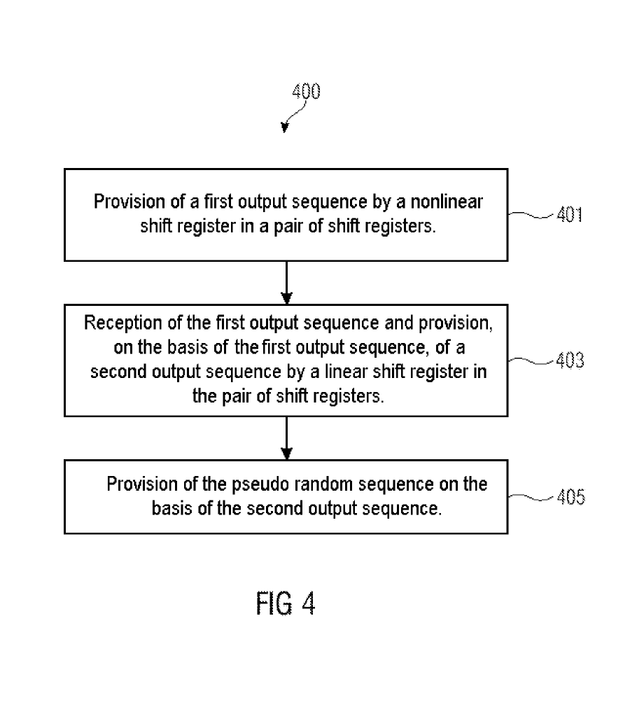

FIG. 4 shows a flowchart for a method 400 for providing a pseudo random sequence based on an embodiment.

The method 400 has a step 401 involving the provision of a first output sequence by a nonlinear shift register.

In addition, the method 400 has a step 403 involving the reception of the first output sequence and the provision of a second output sequence on the basis of the first output sequence by a linear shift register.

In addition, the method 400 includes a step 405 involving the provision of the pseudo random sequence on the basis of the second output sequence.

The method 400 can be performed by various embodiments, such as by the pseudo random number generator 100 or the pseudo random number generator 300. In addition, the method 400 can be extended by all the features of the apparatuses described herein.

Although some aspects have been described in connection with an apparatus, it goes without saying that these aspects are also a description of the corresponding method, which means that a block or an element of an apparatus can also be understood to mean a corresponding method step or a feature of a method step. Similarly, aspects which have been described in connection with or as a method step are also a description of a corresponding block or detail or feature of a corresponding apparatus.

Depending on particular implementation requirements, various embodiments may be implemented in hardware or in software. The implementation can be effected using a digital storage medium, for example a floppy disk, a DVD, a BluRay disk, a CD, a ROM, a PROM, an EPROM, an EEPROM or a flash memory, a hard disk or another magnetic or optical memory on which electronically readable control signals are stored which can interact or do interact with a programmable computer system such that the respective method is performed. Therefore, the digital storage medium may be computer readable. Some embodiments thus include a data storage medium which has electronically readable control signals which are capable of interacting with a programmable computer system such that one of the methods described herein is performed.

In general, various embodiments may be implemented as a computer program product with a program code, said program code being effective to the extent of performing one of the methods when the computer program product is executed on the computer. The program code may also be stored on a machine-readable storage medium, for example.

Other embodiments may include the computer program for performing one of the methods described herein, wherein the computer program is stored on a machine readable storage medium.

In other words, an embodiment of the method is therefore a computer program which has a program code for performing one of the methods described herein when the computer program is executed on a computer. A further embodiment of the methods is therefore a data storage medium (or a digital storage medium or a computer readable medium) on which the computer program for performing one of the methods described herein is recorded.

A further embodiment of the method is therefore a data stream or a sequence of signals which represent(s) the computer program for performing one of the methods described herein. The data stream or the sequence of signals may, by way of example, be configured to be transferred via a data communication link, for example via the Internet.

A further embodiment includes a processing device, for example a computer or a programmable logic element, which is configured or customized to perform one of the methods described herein.

A further embodiment may include a computer on which the computer program for performing one of the methods described herein is installed.

In some embodiments, a programmable logic element (for example a field programmable gate array, FPGA) can be used to perform some or all the functionalities of the methods described herein. In some exemplary embodiments, a field programmable gate array can interact with a microprocessor in order to perform one of the methods described herein. In general, the methods are performed by an arbitrary hardware apparatus in some embodiments. This may be a universal usable piece of hardware, such as a computer processor (CPU), or hardware specific to the method, such as an ASIC.

The embodiments described above are merely an illustration of the principles of the prevent invention. It goes without saying that modifications and variations of the arrangements and details described herein will be apparent to other persons skilled in the art. The intention is therefore for the invention to be limited merely by the scope of protection of the patent claims below rather than by the specific details which have been presented by means of the description and the explanation of the exemplary embodiments herein.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A pseudo random number generator, comprising:
a pair of shift registers, wherein a first shift register in the pair is a linear shift register and a second shift register in the pair is a nonlinear shift register, wherein the linear shift register is configured to receive a first output sequence from the nonlinear shift register, and to take the first output sequence as a basis for providing a second output sequence;
wherein the pseudo random number generator is configured to take the second output sequence as a basis for providing a pseudo random sequence.

2. The pseudo random number generator as claimed in claim 1,
wherein the linear shift register has maximum periodicity.

3. The pseudo random number generator as claimed in claim 1,
wherein the nonlinear shift register has maximum periodicity.

4. The pseudo random number generator as claimed in claim 1,
wherein a length of the nonlinear shift register is less than or equal to a length of the linear shift register.

5. The pseudo random number generator as claimed in claim 1,
wherein a length of the nonlinear shift register is chosen to be in a range between ≧5 and ≦50.

6. The pseudo random number generator as claimed in claim 1,
wherein a length of the linear shift register is chosen to be in a range between ≧5 and ≦50 memory elements longer than a length of the nonlinear shift register.

7. The pseudo random number generator as claimed in claim 1,
wherein the linear shift register has a plurality of memory elements connected up to one another in series; and
wherein the linear shift register has a combinational logic operation which is configured to logically combine an internal output sequence, which is based on a memory element output sequence generated by one of the plurality of memory elements, with the second output sequence.

8. The pseudo random number generator as claimed in claim 7,
wherein a further memory element of the linear shift register is configured to receive a logically combined output sequence resulting from the combinational logic operation in order to take the logically combined output sequence as a basis for providing a further memory element output sequence.

9. The pseudo random number generator as claimed in claim 7,
wherein the internal output sequence is the same as the second output sequence or is the result of one or more combinational logic operations on the second output sequence and one or more memory element output sequences.

10. The pseudo random number generator as claimed in claim 1,
wherein the random number generator has a plurality of corresponding pairs of shift registers; and
wherein the pseudo random number generator is configured to provide the pseudo random sequence on the basis of the second output sequences from the plurality of pairs of shift registers.

11. The pseudo random number generator as claimed in claim 10, further comprising:
a Boolean combination function which is configured to logically combine the second output sequences provided by the plurality of pairs in order to obtain a pseudo random sequence.

12. The pseudo random number generator as claimed in claim 10,
wherein, at least for some of the plurality of pairs, at least one of nonlinear shift registers in different pairs and linear shift registers in different pairs have different lengths.

13. A pseudo random number generator, comprising:
a pair of shift registers, wherein a first shift register in the pair is of a first type and a second shift register in the pair is of a second type, wherein the first shift register is configured to receive a first output sequence from the second shift register, and to take the first output sequence as a basis for providing a second output sequence;
wherein the pseudo random number generator is configured to take the second output sequence as a basis for providing a pseudo random sequence.

14. A pseudo random number generator, comprising:
a plurality of pairs of shift registers, wherein each pair respectively has a linear shift register and a nonlinear shift register, wherein, for each pair, a linear shift register in the pair is configured to receive a first output sequence from a nonlinear shift register in the pair, and to take the first output sequence as a basis for providing a second output sequence;
wherein the linear shift registers and the nonlinear shift registers in the plurality of pairs have maximum periodicity;
wherein, at least for some of the plurality of pairs, a length of the linear shift registers thereof is different than a length of a linear shift register in a further pair from the plurality of pairs or a length of the nonlinear shift register thereof is different than a length of a nonlinear shift register in the further pair or in another pair from the plurality of pairs; and
wherein the pseudo random number generator also has a Boolean combination function which is configured to receive the second output sequences provided by the pairs in order to take the second output sequences as a basis for providing a pseudo random sequence.

15. A method for providing a pseudo random sequence, the method comprising:
providing a first output sequence by a nonlinear shift register in a pair of shift registers;
receiving the first output sequence and providing, on the basis of the first output sequence, a second output sequence by a linear shift register in the pair of shift registers; and
providing the pseudo random sequence on the basis of the second output sequence.

16. A computer program having a program code for carrying out a method for providing a pseudo random sequence when the program is executed on a computer, the method comprising:
providing a first output sequence by a nonlinear shift register in a pair of shift registers;
receiving the first output sequence and providing, on the basis of the first output sequence, a second output sequence by a linear shift register in the pair of shift registers; and
providing the pseudo random sequence on the basis of the second output sequence.
